(19) United States
(12) Patent Application Publication
(10) Pub. No.: US 2018/0373013 A1
(43) Pub. Date: Dec. 27, 2018

(54) OBSERVATION DEVICE AND CONTROL METHOD FOR OBSERVATION DEVICE

(71) Applicant: Olympus Corporation, Tokyo (JP)

(72) Inventor: Satoshi OKAWA, Tokyo (JP)

(21) Appl. No.: 16/013,862

(22) Filed: Jun. 20, 2018

(30) Foreign Application Priority Data
Jun. 27, 2017 (JP) 2017-125296

(51) Int. Cl. G02B 21/24; H04N 5/232

(52) U.S. Cl. CPC G02B 21/245; H04N 5/3572; G02B 21/244; H04N 5/232127

(57) ABSTRACT

An observation device, comprising a focus lens and an image sensor for forming images of a specimen, a motor drive circuit that changes imaging position of the image sensor, a controller that controls focus of the focus lens, a memory that stores a focus map that associates the imaging position with focus control information for focusing on the subject, and a temperature sensor that measures temperature inside the observation device, and wherein the controller corrects data of the focus map stored in the memory based on the imaging position and temperature measured by the temperature sensor, and controls focus based on the focus map that has been corrected.

### CROSS-REFERENCE TO RELATED APPLICATIONS

Benefit is claimed, under 35 U.S.C. § 119, to the filing date of prior Japanese Patent Application No. 2017-125296 filed on Jun. 27, 2017. This application is expressly incorporated herein by reference. The scope of the present invention is not limited to any requirements of the specific embodiments described in the application.

### BACKGROUND OF THE INVENTION

### 1. Field of the Invention

The present invention relates to an observation device and to a focus control method for an observation device that perform focus control of an imaging section when position of the imaging section has been changed.

### 2. Description of the Related Art

It is known to have a cell observation device arranged for a long period of time within a constant temperature oven or incubator that keeps an environment constant, and observe a sample such as cells within a culture vessel using an imaging section. This constant temperature oven or incubator has a sealed structure so as to keep internal temperature and humidity etc. constant. A cell observation device that is arranged inside such as constant temperature oven or incubator for a long period of time has a sealed structure in order to maintain electrical performance.

A microscope system that performs shooting of an observed body that is larger than the field of view of the microscope while moving relative position of a stage and an objective lens is also known (refer to Japanese Patent Laid-open No. 2010-078940 (hereafter referred to as patent publication 1)). With this microscope system a focus map that represents a relationship between shooting position and in focus position of a focus lens is created, and focusing of the objective lens is performed in accordance with this focus map. Further, with the microscope system a microscope housing is distorted by heat from a built in light source, and focus deviates, and so a focus map that corrects in focus position due to thermal factors is created.

As described previously, a cell observation device has a sealed structure in order to maintain electrical performance even inside the constant temperature oven or the incubator. This means, for example, that temperature within the cell observation device will rise with heat generated by motor drive and operation of an image sensor within the cell observation device, the outside of the cell observation device will become distended, and the outside will shrink back again after a period of non-operation. As a result, a transparent top plate that supports an observation surface for a culture medium that has had cells etc. placed in it will be bent. Also, because of the sealed structure a pressure difference arises between the inside and the outside of the cell observation device, and for the same reason displacement of the observation surface occurs with the occurrence of bending and indenting of the top plate. With the microscope system disclosed in patent publication 1, there is no mention whatsoever regarding correction of focus variation due to displacement of the observation surface, such as deformation of the top plate caused by pressure difference and temperature difference etc.

### SUMMARY OF THE INVENTION

The present invention provides an observation device and focus control method for an observation device that correct focus variation due to displacement of an observation surface course by pressure difference and temperature difference etc.

An observation device of a first aspect of the present invention comprises: a focus lens and an image sensor for forming images of a specimen, a motor drive circuit that changes imaging position of the focus lens and the image sensor on an XY plane, a controller that controls focus of the focus lens, a memory that stores a focus map that associates the imaging position with focus control information to focus on the specimen, and a temperature sensor that measures temperature inside the observation device, wherein, the controller corrects data of the focus map stored in the memory based on the imaging position and temperature measured by the temperature sensor, and controls focus based on the focus map that has been corrected.

A control method for an observation device of a second aspect of the present invention that has a focus lens and an image sensor for forming images of a specimen, and also a memory that stores a focus map that associates the imaging position with focus control information to focus on the specimen, the control method comprising: changing imaging position of the focus lens and the image sensor on an XY plane, measuring temperature inside the observation device, and correcting data of the focus map stored in the memory based on the imaging position and temperature measured by the temperature sensor, and controlling focus of the focus lens based on the focus map that has been corrected.

A non-transitory computer-readable medium storing a processor executable code of a third aspect of the present invention which when executed by at least one processor, performs an control method for an observation device that has a focus lens and an image sensor for forming images of a specimen, and also a memory that stores a focus map that associates the imaging position with focus control information to focus on the specimen, the control method comprising: changing imaging position of the image sensor, measuring temperature inside the observation device, and correcting data of the focus map stored in the memory based on the imaging position and temperature that has been measured, and controlling focus of the focus lens based on the focus map that has been corrected.

### BRIEF DESCRIPTION OF THE DRAWINGS

FIG. 1 is a perspective drawing looking from diagonally above, showing usage state of a cell observation device of one embodiment of the present invention.

FIG. 2A and FIG. 2B are block diagrams mainly showing the electrical structure of a cell observation device of one embodiment of the present invention.

FIG. 3 is a graph showing a focusing point detection principle at the time of an AF (Auto Focus) operation, in the cell observation device of one embodiment of the present invention.

FIG. 4A and FIG. 4B are drawings for explaining focus correction for the cell observation device of one embodiment of the present invention, with FIG. 4A showing a case where a top board is horizontal, and FIG. 4B showing a case here the top board is inclined.

FIG. 5 is a graph for explaining focus correction in the cell observation device of one embodiment of the present invention.

FIG. 6 is a drawing showing operation sequences for movement of position of an imaging section (X-Y stage drive) and focus lens drive (LD drive), in the cell observation device of one embodiment of the present invention.

FIG. 7 is a drawing for explaining focus deviation correction due to X/Y position of an imaging section, with the cell observation device of one embodiment of the present invention.

FIG. 8 is a table showing a relationship between X/Y position of an imaging section and focus correction amount, with the cell observation device of one embodiment of the present invention.

FIG. 9 is a table showing a relationship between X/Y position of an imaging section and focus correction amount, with the cell observation device of one embodiment of the present invention.

FIG. 10 is a graph for explaining interpolation calculation for focus deviation amount in the cell observation device of one embodiment of the present invention.

FIG. 11 is a table showing correction of focus deviation amount due to temperature, with the cell observation device of one embodiment of the present invention.

FIG. 12 is a table showing correction of focus deviation amount due to pressure, with the cell observation device of one embodiment of the present invention.

FIG. 13 is a flowchart showing main operation of for cell observation, with the cell observation device of one embodiment of the present invention.

FIG. 14 is a flowchart showing operation for focus deviation (focus deviation: Fc) correction drive with the cell observation device of one embodiment of the present invention.

FIG. 15 is a flowchart showing operation of Fc correction pulse calculation, in the cell observation device of one embodiment of the present invention.

FIG. 16 is a flowchart showing operation of drive backlash correction determination in the cell observation device of one embodiment of the present invention.

FIG. 17 is a flowchart showing operation of correction target pulse calculation, in the cell observation device of one embodiment of the present invention.

### DETAILED DESCRIPTION OF THE PREFERRED EMBODIMENTS

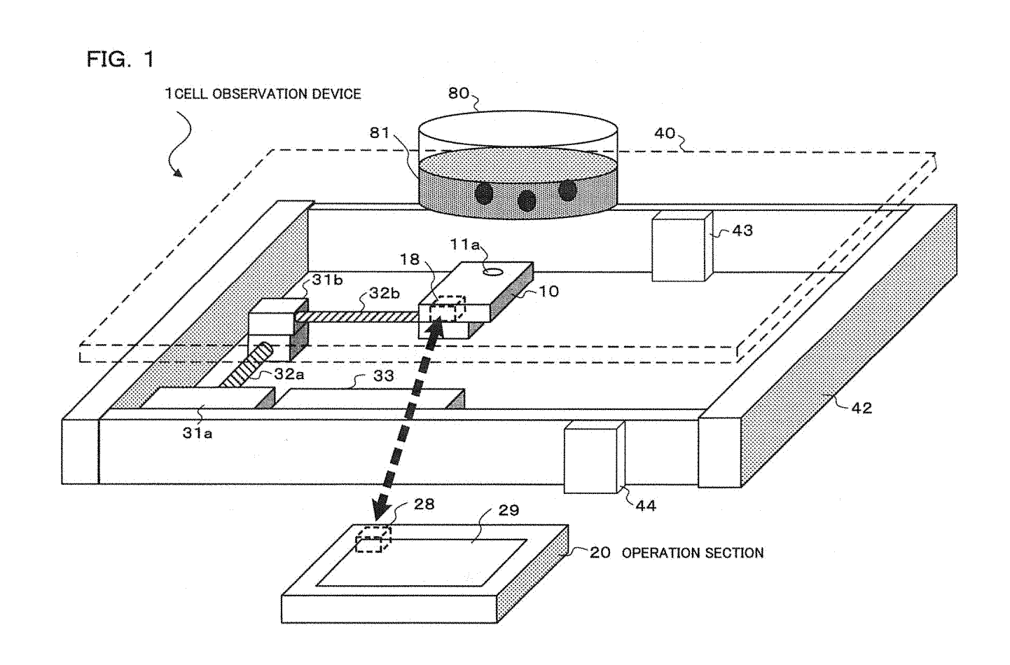

Using the drawings, an example applied to a cell observation system will be described in the following as one embodiment of the present invention. FIG. 1 is a perspective view showing the overall structure of a cell observation system, with this cell observation system having a cell observation device 1 and an operation section 20, the cell observation device 1 being arranged, for example, within a constant temperature oven or incubator that keeps the internal environment (temperature, humidity etc.) of the cell observation device constant, and the operation section 20 being arranged outside the incubator etc. The cell observation device 1 has a sealed structure.

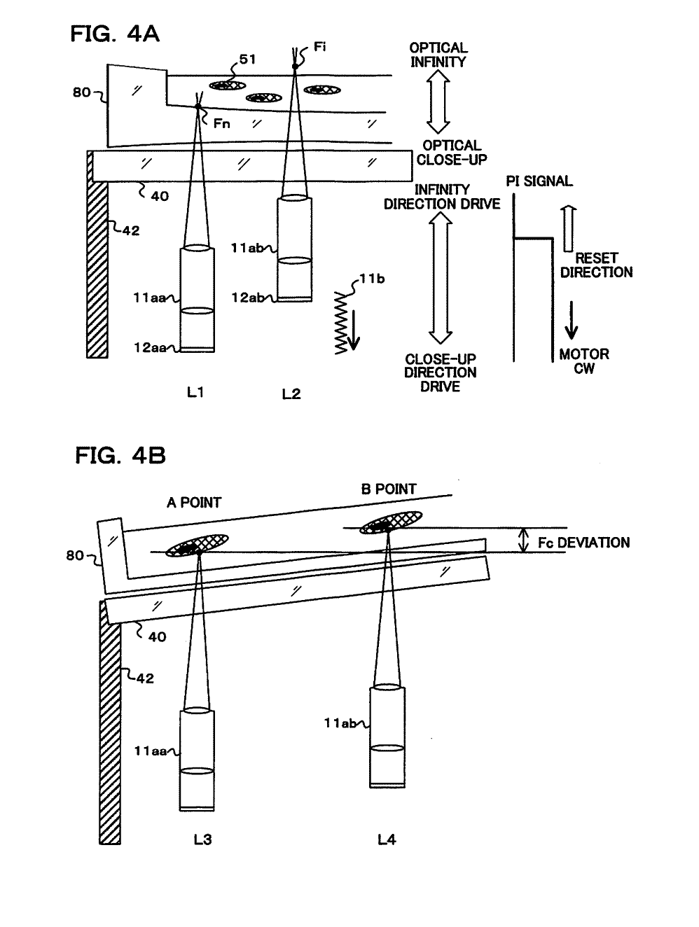

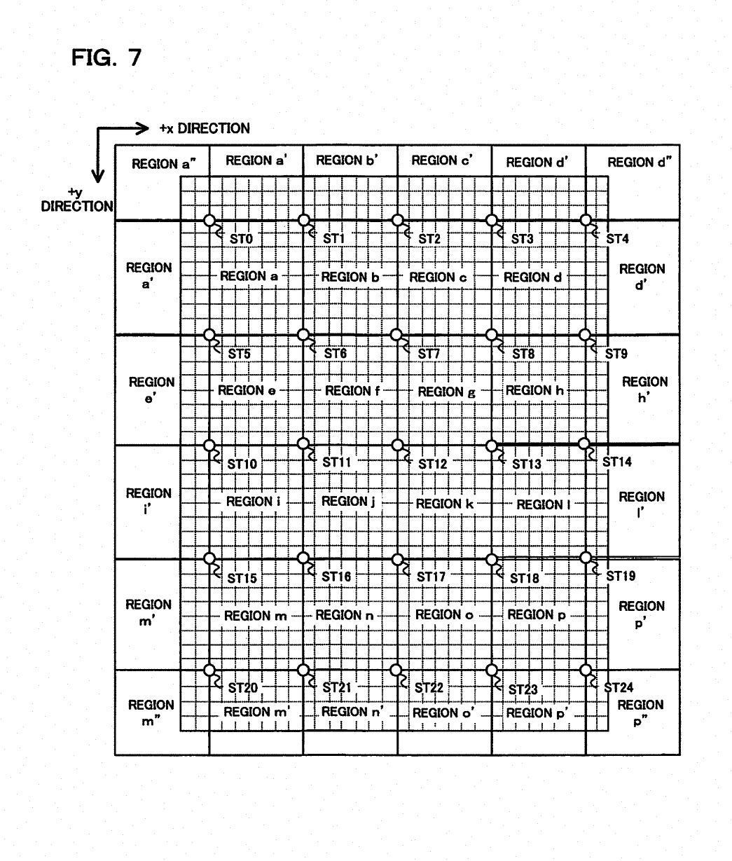

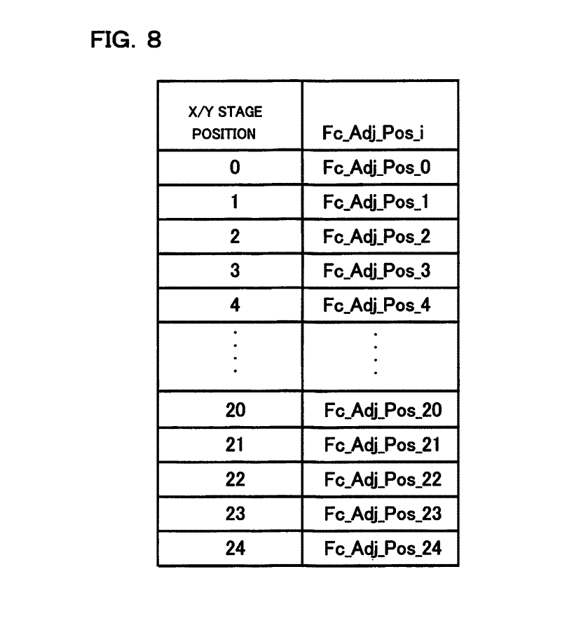

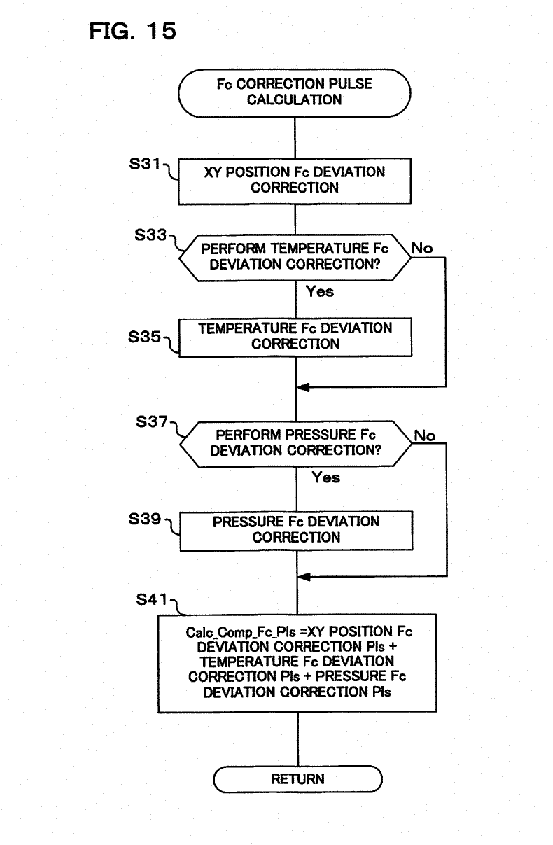

A vessel 80 is mounted on a transparent top board 40 of the cell observation device 1, and the cell observation device 1 can form images of a specimen 81 that has been cultivated in the vessel 80 through the transparent top board 40 and acquire taken images. This means that it is possible to cultivate cells inside an incubator etc., with environment maintained, and to perform measurement and observation of a specimen 81 or the like using the operation section 20 etc. outside of the incubator. Since observation and measurement of the cells that have been cultivated inside the incubator are performed remotely, it is desirable for the cell observation device 1 to have an energy saving and high reliability design. A specimen is arranged on the top board 40, and the top board 40 functions as a transparent plate arranged between the specimen and the imaging section. The top board 40 is deformed by temperature of the cell observation device 1 and pressure inside and outside of the cell observation device etc. As a result of this, focus of an image that has been formed by the camera section 10 changes. With this embodiment, deformation of the transparent plate is estimated and a focus map is corrected (refer, for example, to FIG. 4A, FIG. 4B, FIG. 7, FIG. 8, and S31 and S41 in FIG. 15).

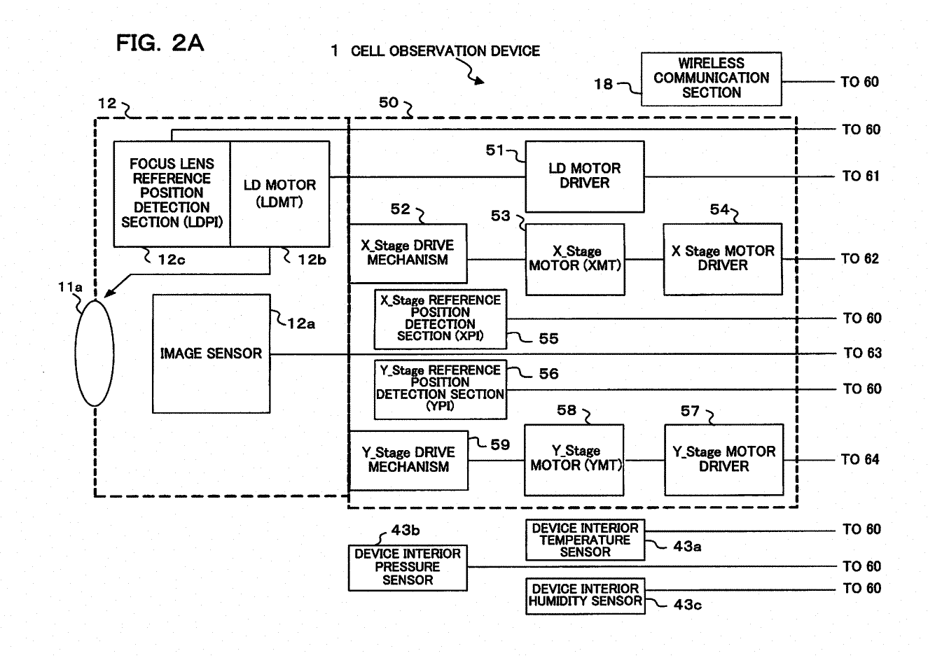

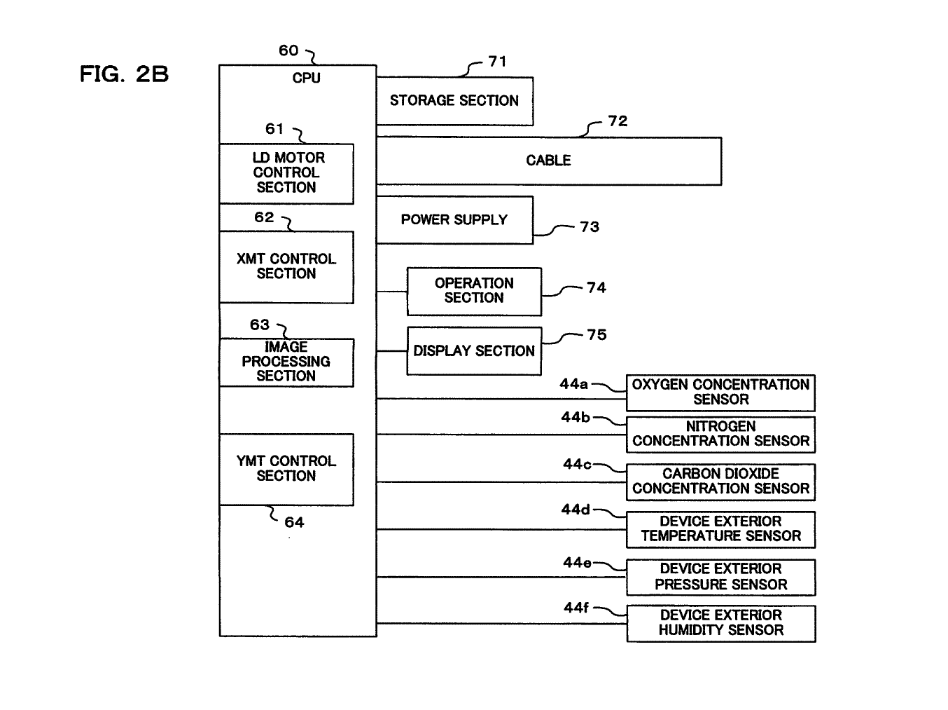

The cell observation device 1 has a camera section 10, Y actuator 31a, X actuator 31b, Y feed screw 32a, X feed screw 32b, movement control section 33, transparent top board 40, and outer housing 42. The camera section 10 has a lens 11a, with an image that has been formed by the lens 11a being subjected to photoelectric conversion by an imaging section 11 (refer to FIG. 2A) to acquire image data. Also, a wireless communication device 18 is arranged inside the camera section 10, and wireless communication is possible with a communication section 28 within the operation section 20 that is arranged externally to the cell observation device 1. The detailed structure of the camera section 10 will be described later using FIG. 2A.

The camera section 10 is held on an X feed screw 32b, and is capable of moving in the X axis direction by rotation of the X feed screw 32b. The X feed screw 32b is driven to rotate by the X actuator 31b. The X actuator 31b is held on the Y feed screw 32a, and is capable of movement in the Y axis direction by rotation of the Y feed screw 32a. The Y feed screw 32a is driven to rotate by the Y actuator 31a. The camera section 10 can move within a plane that is horizontal to a determined plane (XY plane) by the X feed screw 32b and Y feed screw 32a.

The movement control section 33 has a drive control circuit, and performs drive control for the Y actuator 31a and the X actuator 31b, and performs drive control of the camera section 10 in the X axis and Y axis directions in accordance with a procedure that has been preprogrammed. It is also possible for the user to move the camera section 10 to a specified position, and in this case, since a manual operation is instructed by the operation section 20, the movement control section 33 moves the camera section 10 in accordance with the user's instruction.

It should be noted that, as will be described later, a power supply section 73 having a built in power supply battery is provided inside the cell observation device 1, and supplies power to the movement control section 33, Y actuator 31a, X actuator 31b, and camera section 10, and a communication line is also provided for bidirectional communication of control signals between each of the sections. With this embodiment it is assumed that a power supply battery is used as the power supply but this is not limiting, and supply of power may also be implemented using an AC power supply. It is also assumed that control signals between each of the sections are interchanged by means of wired communication, but it is also possible to use wireless communication.

The above described camera section 10, Y actuator 31a, X actuator 31b, Y feed screw 32a, X feed screw 32b, and movement control section 33 are arranged inside the top board 40 and outer housing 42. The top board 40 and outer housing 42 constitute an encapsulating structure such that moisture does not infiltrate into the inside from outside. As a result the inside of the top board 40 and the outer housing 42 are not subjected to high humidity, even if the inside of the incubator is high humidity. The outer housing 42 is used together with the transparent board (top board 40) to function as a housing that puts the inside of the observation device in a sealed state.

A built-in sensor 43 is arranged inside the outer housing 42. The built-in sensor 43 includes various sensors, and as the various sensors there are a temperature sensor for detecting temperature inside the cell observation device 1, a pressure sensor for detecting pressure, and a humidity sensor for detecting humidity, etc. There may be only one or two of these three sensors, and sensors for detecting other items may also be arranged. Also, arrangement position does not need to be at a single location, and the sensors may be arranged suitably dispersed.

An external sensor 44 is arranged outside the outer housing 42. The external sensor 44 includes various sensors, and as the various sensors there are a temperature sensor for detecting temperature outside the cell observation device 1, a pressure sensor for detecting pressure, a humidity sensor for detecting humidity, an oxygen concentration sensor for detecting oxygen concentration, a nitrogen concentration sensor for detecting nitrogen concentration, a carbon dioxide concentration sensor for detecting carbon dioxide concentration, etc. There may be one or a plurality of any of these six sensors, and sensors for detecting other items may also be arranged. Also, arrangement position does not need to be at a single location, and the sensors may be arranged suitably dispersed.

It is possible to mount the vessel 80 on the upper side of the transparent top board 40, and it is possible to fill a culture medium into the inside of the vessel 80 and cultivate a specimen 81 (cells). The camera section 10 can form images of a culture medium within the vessel 80 through the transparent top board 40 and acquire images. It is also possible to count a number of cells of the specimen 81 by analyzing images. Specifically, it is possible to form images of the specimen 81 within the vessel 80 while moving the camera section 10 within the XY plane using the X actuator 31a and the Y actuator 31b, and to count the cells.

The operation section 20 has a communication section 28, and can perform wireless communication with the wireless communication device 18 inside the cell observation device 1. This means that it is possible for the operation section 20 to carry out communication with the camera section 10 from a position that is isolated from the cell observation device 1, and it is possible to move the camera section 10 and to receive image data that has been acquired by the camera section 10. It should be noted that the operation section 20 may be a dedicated unit, or an information terminal device such as a smartphone may also double as the operation section. Further, an operation section that belongs to a computer such as a personal computer (PC) or a server may also be used for the operation section 20.

Also, the operation section 20 has a display section (display) 29, and the display section 29 performs display of icons used for various modes of the operation section 20 and various settings etc. If a touch panel is provided, it is possible to carry out various inputs using a touch operation. The display section 29 also displays images that have been acquired and transmitted by the camera section 10.

Next, the electrical structure of the cell observation device 1 of this embodiment will mainly be described using FIG. 2A and FIG. 2B. The cell observation device 1 has a lens drive (LD) unit 12, X/Y stage section 50, CPU (Central Processing Unit) 60, built-in sensor 43, external sensor 44 and other peripheral circuits etc.

The lens drive (LD) unit 12 is provided within the camera section 10, and has a focus lens 11a. This focus lens 11a is a prime lens or a zoom lens, and forms images of the specimen 81, such as cells etc., on the image sensor 12a. While FIG. 2A does not show an aperture and mechanical shutter on the optical axis of the focus lens 11a, these components may be provided, or they may be omitted.

The image sensor 12a is a CCD image sensor or a CMOS image sensor, that generates image data by subjecting an image that has been formed by the focus lens 11a to photoelectric conversion, performs processing such as A/D conversion in an imaging circuit, and outputs to an image processing section 63. The image sensor 12a functions as an image sensor for forming images of the specimen. The image sensor is capable of imaging corresponding to still images, and imaging corresponding to live view.

The focus lens 11a is moved in the optical axis direction of the focus lens 11a by a lens drive (LD) motor (LDMT) 12b. The LD motor 12b is a stepping motor in this embodiment, but maybe another type of motor (also including an actuator).

A focus lens reference position detection section (LDPI) 12c has a photo interrupter or the like, and outputs a reference position signal to the CPU 60 when the focus lens 11a reaches a reference position. This reference position signal is made a reference point, and it is possible to detect position of the focus lens 11a based on a number of pulses that have been applied to the stepping motor. Based on this position detection an LD motor control section 61 can move the focus lens 11a to a focus position that is made a target position. It should be noted that in the case of a motor other than a stepping motor, a sensor may be provided to detect relative or absolute position of the focus lens 11a.

The X/Y stage section 50 is a mechanism for moving position of the LD unit (camera section 10) in the X direction and Y direction, and is equivalent to the Y actuator 31a, X actuator 31b, movement control section 33 etc. of FIG. 1.

An LD motor driver 51 is a drive circuit for the LD motor 12b, and outputs drive pulses for the LD motor 12b in accordance with a control signal from the LD motor control section 61 within the CPU 60. The above described LD motor 12b and the LD motor driver 51, and the LD motor control section 61 which will be described later, function as a focus control section that controls focusing of the imaging section. The above described LD motor 12b and the LD motor driver 51, and the LD motor control section 61 which will be described later, function as a focus control circuit that controls focusing of the focus lens.

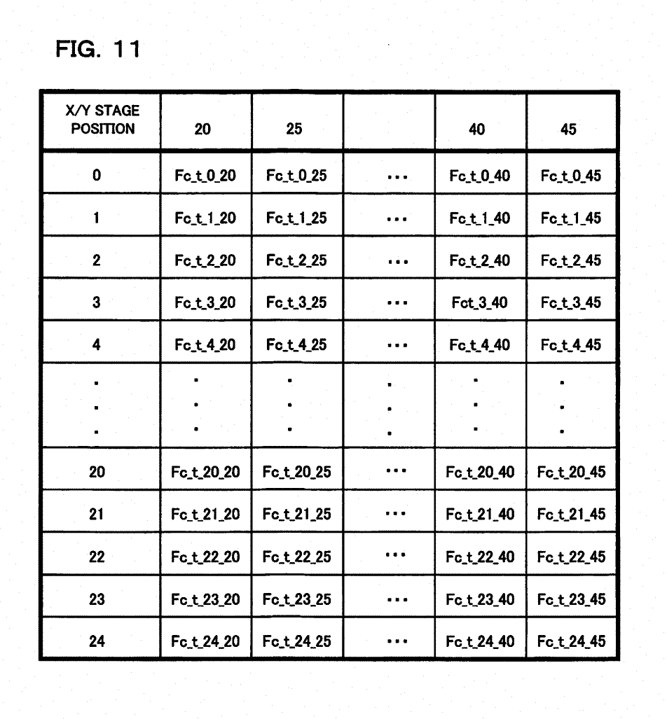

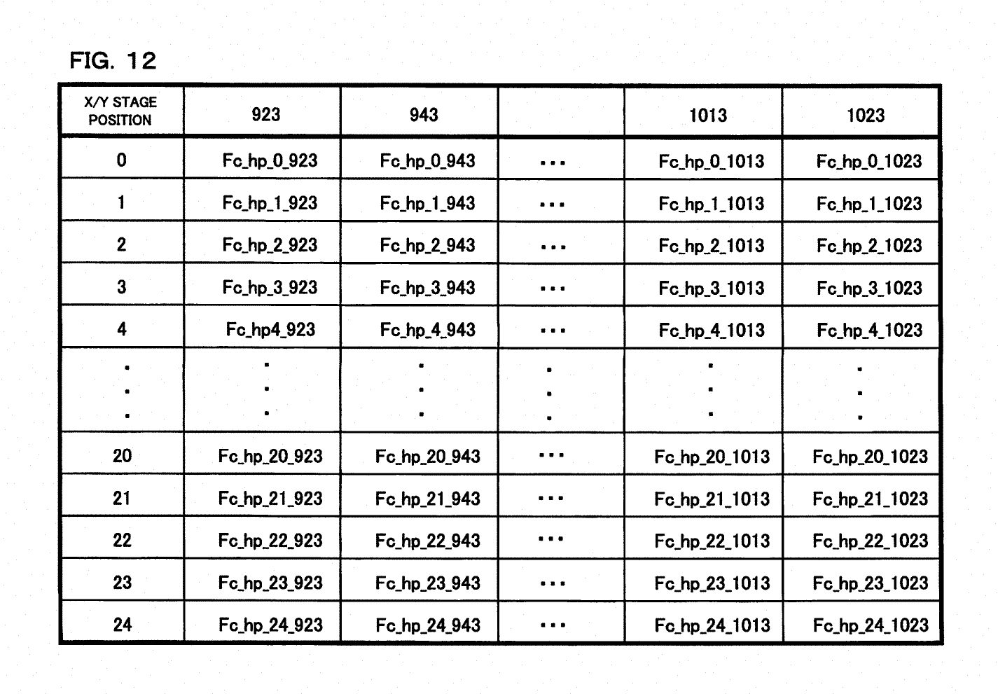

A controller (focus control circuit) corrects data of a focus map stored in memory (focus map storage section) based on imaging position and temperature measured by a temperature sensor (temperature measurement section), and controls focus based on the focus map that has been corrected (refer to FIG. 11 and S35 and S41 in FIG. 15). The controller (focus control circuit) corrects the focus map based on pressure measured by the pressure sensor (pressure measurement section) (refer to FIG. 12 and S39 and S41 in FIG. 15). The controller (focus control circuit) corrects the focus map based on acquired information of environment sensors (environment information acquisition section). For example, the focus map may be detected based on detection results of at least one of various sensors within the external sensor 44.

The controller (focus control circuit) corrects the focus map by estimating a change in a light path at the time of imaging a specimen by the image sensor (refer, for example, to FIG. 11, FIG. 12, and S35, S39 and S41 in FIG. 15). Specifically, the focus map is corrected in accordance with change due to temperature and pressure etc.

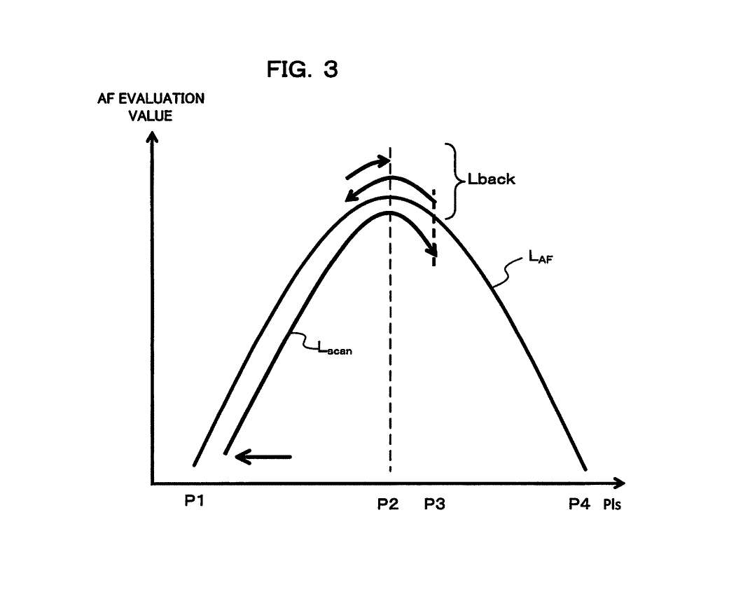

The controller (focus control circuit) is capable of adjusting focus of the focus lens based on image information that was formed by the image sensor so that contrast becomes a peak (refer to FIG. 3), and in a case where the image sensor performs an imaging operation corresponding to live view the controller (focus control section) controls focus based on a focus map that has been corrected, while in a case where the image sensor performs an imaging operation corresponding to still images the controller (focus control circuit) controls focus so that contrast becomes a peak.

The controller (focus control circuit) corrects data of a stored focus map based on imaging position that has been changed by the motor drive circuit (imaging position change section), and controls focus based on the corrected focus map (refer to S31 and S41 in FIG. 15).

An X stage drive mechanism 52 is a mechanism for driving the camera section 10 in the X axis direction, and is equivalent to the X feed screw 32b in FIG. 1. It should be noted that the X stage drive mechanism 52, besides being a feed screw mechanism, may be a mechanism for causing the camera section 10 to move spatially in the X axis direction, such as a gear mechanism or a belt mechanism. An X stage motor (XMT) 53 is a motor for causing rotation of the X feed screw 32b, and in this embodiment a stepping motor is adopted. The X stage motor 53 is pulse driven by an X stage motor driver 54. The X stage motor driver 54 performs drive control of the X stage motor 53 in accordance with a control signal from an XMT control section 62 within the CPU 60.

An X stage reference position detection section 55 has a detection sensor such as light sensor like a PI (photo interrupter) or PR (photo reflector), or a magnetic sensor etc., and outputs a reference signal to the CPU 60 when the camera section 10 has reached a reference position in the X axis direction. The XMT control section 62 can move the camera section 10 to a target position in the X axis direction by applying pulses to the X stage motor 53 based on this reference position.

A Y stage drive mechanism 59 is a mechanism for driving the camera section 10 in the Y axis direction, and is equivalent to the Y feed screw 32a in FIG. 1. It should be noted that the Y stage drive mechanism 59, besides being a feed screw mechanism, may be a mechanism for causing the camera section 10 to move spatially in the Y axis direction. AY stage motor (YMT) 58 is a motor for causing rotation of the Y feed screw 32a, and in this embodiment a stepping motor is adopted. The Y stage motor 58 is pulse driven by a Y stage motor driver 57. The Y stage motor driver 57 performs drive control of the Y stage motor 58 in accordance with a control signal from a YMT control section 64 within the CPU 60.

A Y stage reference position detection section 56 has a detection sensor such as light sensor like a PI (photo interrupter) or PR (photo reflector), or a magnetic sensor etc., and outputs a reference signal to the CPU 60 when the camera section 10 has reached a reference position in the Y axis direction. The YMT control section 64 can move the camera section 10 to a target position in the Y axis direction by applying pulses to the Y stage motor 58 based on this reference position.

The above described X stage motor driver 54, X stage motor 53, X stage drive mechanism 52, X stage reference position detection section 55, Y stage motor driver 57, Y stage motor 58, Y stage drive mechanism 59, and Y stage reference position detection section 56 function as an imaging position change section that changes imaging position of the imaging section. Also, the above described X stage motor driver 54, X stage motor 53, X stage reference position detection section 55, Y stage motor driver 57, Y stage motor 58, and Y stage reference position detection section 56 function as an imaging position change circuit. The X stage motor driver 54 and the Y stage motor driver function as a motor drive circuit that changes imaging position of the image sensor on an XY plane.

The CPU 60 performs control for each section within the cell observation device 1 in accordance with a program that is stored in a storage section 71. Within the CPU 60 there are the lens drive (LD) motor control section 61, X motor (XMT) control section 62, image processing section 63, and Y motor (YMT) control section 64. Each of these sections is realized in a software manner using a program, but some functions of each of the control section 61, 62, and 64 and/or the image processing section 63 etc. may be realized using hardware circuits etc.

The LD motor control section 61 controls focusing of the focus lens 11a by performing drive control of the lens drive (LD) motor 12b. The XMT control section 62 performs positional adjustment of the camera section 10 in the X axis direction by performing drive control of the X stage motor 53. The YMT control section 64 performs positional adjustment of the camera section 10 in the Y axis direction by performing drive control of the Y stage motor 58.

The image processing section 63 has an image processing circuit, and processes image data from the image sensor 12a, performs image displayed on the display section 75, and displays images of the specimen 81 etc. on an external display section (for example, the display section 29 of the operation section 20) via a communication cable within the cable 72. The image processing section 63 may also perform image analysis such as counting a number of specified cells within the specimen 81. Further, the image processing section 63 calculates an AF evaluation value based on image data.

The storage section 71 has electrically rewritable volatile memory and/or electrically rewritable non-volatile memory. Besides the previously described program, the storage section 71 may also store various adjustment values for the cell observation device 1, and may also store a predetermined movement path for the camera section 10 at the time of cell observation. The storage section 71 functions as a memory (focus map storage section) that stores a focus map in association with imaging position and focus control information for focusing on the specimen.

The cable 72 is a communication cable for when connecting between the cell observation device 1 and the operation section 20 in a wired manner. Image data that has been acquired by the image sensor 12a is transmitted externally by means of this communication cable. In the case of wireless communication, this communication cable may be omitted. The cable 72 is also a power supply cable in the case of supplying power to the cell observation device 1 from outside. In the event that a power supply battery is built into the cell observation device 1, the cable may be omitted. A power supply section 73 receives supply of power from outside by means of the cable 72 or using the built-in battery, and converts to a power supply voltage used by the cell observation device 1.

An operation section 74 is an input interface, and has switches for performing on-off control of the power supply, and on-off control of communication with the operation section using wireless communication etc. Besides this, the operation section 74 may also include switches, a dial or a touch panel etc. for performing some operations using the operation section 20. The display section 75 has a display, and displays images of the specimen 81 etc., that have been processed by the image processing section 63 of the CPU 60. It should be noted that the display section 75 may be omitted and images displayed only on an external unit. The display section 75 functions as a display (display section) that displays images of the specimen based on imaging output of the image sensor.

Within the previously described built-in sensor 43 there are a device interior temperature sensor 43a, device interior pressure sensor 43b and a device interior humidity sensor 43c. The device interior temperature sensor 43a detects temperature within the outer housing 42 and outputs to the CPU 60. The device interior pressure sensor 43b detects pressure within the outer housing 42 and outputs to the CPU 60. The device interior humidity sensor 43c detects humidity within the outer housing 42 and outputs to the CPU 60.

The device interior temperature sensor 43a functions as a temperature sensor (temperature measurement section) that measures temperature inside the observation device. The device interior pressure sensor 43b functions as a pressure sensor (pressure measurement section) that measures pressure inside the observation device.

Within the previously described external sensor 44 there are an oxygen concentration sensor 44a, a nitrogen concentration sensor 44b, a carbon dioxide concentration sensor 44c, a device exterior temperature sensor 44d, a device exterior pressure sensor 44e and a device exterior humidity sensor 44f. The oxygen concentration sensor 44a, nitrogen concentration sensor 44b, and carbon dioxide concentration sensor 44c detect oxygen concentration, nitrogen concentration and carbon dioxide concentration outside the outer housing 42, that is in the vicinity of the specimen 81 such as cells, and output detection results to the CPU 60. Also, the device exterior temperature sensor 44d, device exterior pressure sensor 44e, and device exterior humidity sensor 44f detect temperature, pressure and humidity outside the outer housing 42 and output detection results to the CPU 60.

At least one among these external sensors 44 functions as an environment sensor (environment information acquisition section) that acquires information relating to the environment in which the observation device is arranged. The information relating to environment described above is temperature or pressure of the environment.

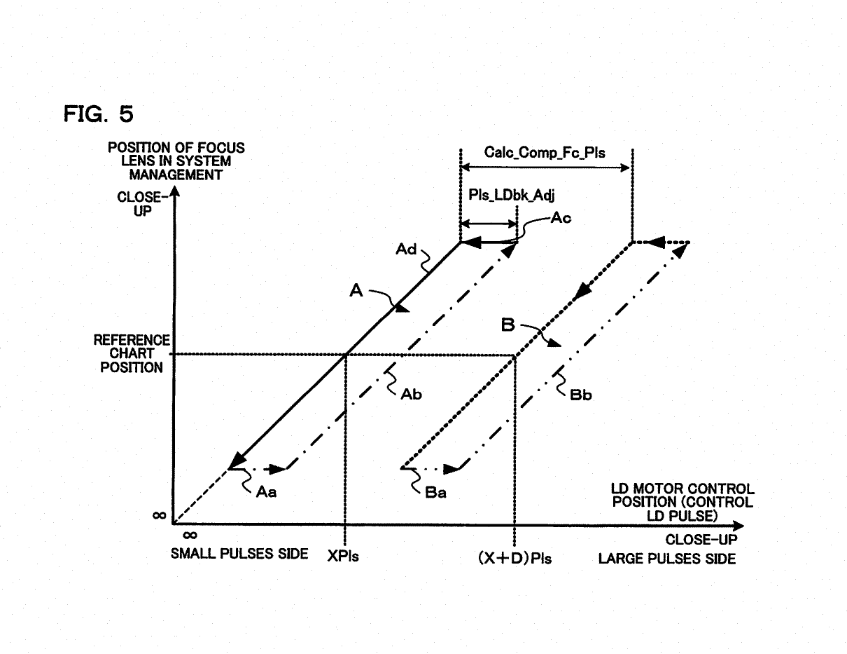

Next, focus control of the focus lens 11a of this embodiment will be described using FIG. 3. With this embodiment a so-called contrast method is adopted for focus control, with which an AF evaluation value (contrast value) is calculated based on image data, and a focus position of the focus lens 11a at which this AF evaluation value becomes a peak is made an in focus position. It should be noted that in this embodiment the focus control using a contrast method is performed when acquiring image data such as still images, and is not used with focus control when performing so-called live view display. With live view display, as will be described using FIG. 5 to FIG. 13, focus deviation amount is stored and focus control of the focus lens 11a is performed using correction based on this deviation amount.

In FIG. 3, the horizontal axis represents position of the focus lens 11a in the optical axis direction. In this embodiment a stepping motor is adopted as the lens drive (LD) motor 12b, as was described previously. Therefore, a number of pulses (Pls) that have been applied to the stepping motor from a point in time where a reference position has been detected by the focus lens reference position detection section 12c represents position of the focus lens 11a in the optical axis direction. The vertical axis represents AF evaluation value that has been calculated from image data that has been acquired by the image sensor 12a.

In FIG. 3, a curve L_{AF} shows an example of AF evaluation values for each position of the focus lens 11a in the optical axis direction. In detecting in focus position using a contrast method, as shown by arrow Lscan the focus lens 11a is driven from position P1 in the direction of position P4, image data is acquired by the image sensor 12a, and the image processing section 63 calculates AF evaluation value based on the image data that has been acquired. If in focus position P2 is exceeded the AF evaluation value passes a peak and starts to decrease. If the AF evaluation value begins to decrease, drive of the focus lens 11a is stopped (refer to position P3) and backlash cancellation drive is performed as shown by Lback. After that, as shown by Lback, the focus lens 11a is driven to in focus position P2 and the focus lens 11a is stopped at in focus position P2.

Next, focus adjustment (in this specification also referred to as fc adjustment) of this embodiment will be described using FIG. 4A and FIG. 4B. This focus adjustment (Fc adjustment) is adjustment to obtain an adjustment value that is used in a focus adjustment operation at the time of live view observation of a specimen, such as cells, and is performed using automatic focus adjustment (AF) using the contrast method that was described using FIG. 3.

FIG. 4A shows a case where the transparent top board 40 has a positional relationship of being orthogonal to the outer housing 42. FIG. 4A and FIG. 4B show an example of a focusing system for a photographing lens which is an entire extension system, and with this system a photographing lens that includes the focus lens 11a and the image sensor 12a are constructed to move together in the optical axis direction. With the example shown in FIG. 4A, when the focus lens 11a is positioned at position L1 the optical axis of the focus lens 11aa and the image sensor 12aa is orthogonal to the top board 40, and when the focus lens 11a is positioned at position L2 the optical axis of the focus lens 11ab and the image sensor 12ab is orthogonal to the top board 40. The focus lenses 11aa and 11ab are urged in the direction of the arrow (downward direction) by a spring lib, and it is possible to move the focus position in the infinity direction or in the close-up direction by applying a Pls signal to the LD motor 12b.

In FIG. 4A, focus position of the focus lens 11aa is at optical close-up Fn, while focus position of the focus lens 11ab is at optical infinity Fi. When the top board 40 has a positional relationship orthogonal to the outer housing 42, position where the focus lens 11a is in focus will not change even if the focus lens 11a (and image sensor 12a) is moved horizontally.

FIG. 4B shows a case where the transparent top board 40 is inclined with respect to the outer housing 42. In this case, if the focus lens 11a is moved horizontally focused position within the vessel 80 will change. With the example shown in FIG. 4B, when the focus lens 11a is at position L3 focus position of the focus lens 11aa is at point A. Also, if the focus lens 11a is moved as it is horizontally to position L4 the focus position of the focus lens 11ab becomes point A, and a range distance difference between point A and point B in the optical axis direction, namely a focus deviation (Fc), arises. Therefore, as shown in FIG. 4B, at position L4 it is necessary to set focus position at point B by moving the focus lens 11a in the infinity direction by an amount corresponding to this focus deviation (Fc deviation). It should be noted that inclination has been shown with the outer housing 42 as a reference, but the same problem also arises with another reference, such as the optical axis of the photographing lens.

In this way, in a case where the top board 40 is inclined when displaying cells using through image (live view display), while moving the camera section 10 from an arbitrary coordinate position within a plane (X:Y) to another arbitrary coordinate position, deviation in focus position will occur in the focus lens 11a (FC deviation shown in FIG. 4B). Images that are out of focus will be subjected to live view display. In this case, inclination and distortion of the top board 40 occur caused by dispersion in members, namely X/Y stage position of the camera section 10 (problem 1). It should be noted that at the time of live view display, if an AF operation is performed using a contrast method accompanying movement of the camera section 10, quality of live view display is poor due to time lag and display blur due to a lens scan operation etc. at the time of AF operation. For this reason an AF operation using a contrast method is not performed at the time of performing a live view operation. Instead, only focus drive to correct Fc deviation is performed.

On the basis of problem a described above, Fc depending on individual XY positions is adjusted at the factory at the time of manufacture, and corrected. Specifically, in factory adjustment at the time of manufacture focus adjustment is performed at a predetermined (X:Y) coordinate. An (X:Y) coordinate drive before drive, and lens drive amount during drive and after drive are measured, Fc deviation amount is calculated using these measurement results, and this Fc deviation amount is stored in the storage section 71. Fc deviation is adjusted based on this Fc deviation amount. This adjustment is called Fc adjustment using XY position.

The top board 40 is also distorted by change in the environment where the cell observation device 1 is arranged. The cell observation device 1 has a sealed structure in order to maintain electrical performance, and a temperature difference and pressure difference arise between the inside and outside of the outer housing 42. Generally, a central section of the top board 40 has low rigidity and amount of deformation is large, while peripheral sections has small amount of deformation. Also, the top board 40 is distended in a barrel shape due to the effects of temperature and pressure, and winding side depressions occur. Fc deviation occurs due to temperature and pressure such as these phenomenon (problem 2). For Fc deviation based on this problem 2, information on temperature/pressure under the operation environment is acquired, and Fc correction corresponding to an (X:Y) coordinate position, namely correction of focus position of the focus lens 11a, is performed. Hereafter this correction will be called FC correction using temperature/pressure.

Next, correction of focus position of the focus lens 11a in accordance with coordinate, namely Fc correction control, will be described using FIG. 5. In FIG. 5, the horizontal axis represents control position of the focus lens 11a in the optical axis direction (control LD pulse), and represents a control position resulting from a number of pulses that have been applied to the LD motor 12b from a reference position of the focus lens 11a (control LD pulse). The left side of the horizontal axis represents an infinity end direction of the focus lens 11a, while the right side represents the close-up end direction. The vertical axis represents an administrative position (pulse) of the focus lens 11a. The lower side of the vertical axis represents the infinity end direction while the upper side represents the close-up end direction.

Here, description will be given of system administration position of the focus lens 11a. As was described previously, the cell observation device 1 and the operation section 20 are capable of performing communication, and the user can control the cell observation device 1 using the operation section 20. The user designates a position (XY position) of the focus lens by operation of the operation section 20, designated position data is transmitted from the operation section 20 to the cell observation device 1, and the cell observation device 1 moves the focus lens to the designated position based on the designated position data that has been received. Then, in the cell observation device 1, image data that has been formed by the camera section 10 is acquired, and image data is transmitted to the operation section 20. At the operation section 20 the image data that has been received is displayed on the display device of the operation section, and it is possible to show images of the specimen, such as cells, to the user. At this time, position data of the focus lens used in communication between the operation section 20 and the cell observation device 1 is called system administration position (data).

System administration position data is data in one to one correspondence with distance (focus position) of the subject that is being focused on (specimen, such as cells). System administration position data does not include backlash correction value an Fc correction value components. In the cell observation device 1, control LD pulse resulting from adding backlash correction value and Fc correction value is calculated for system administration position data that has been received from the operation section 20, to control the focus lens position. Also, position of the focus lens after the focus lens has been driven (control LD pulse) is converted to system administration position data and transmitted to the operation section 20. In this way, in the operation section 20 it is possible to control position of the focus lens without considering backlash correction value and Fc correction value.

In FIG. 5, loops A shows a case where correction of focus position (Fc pulse correction) of the focus lens 11a is 0, while loop B shows a case where focus position correction has a value that is not 0. Loop A corresponds, for example, to the center of a movement range of the camera section 10 (ST12 in FIG. 7), and loop B corresponds to other than the center. In FIG. 5, a case is shown where adjustment to determine position of the focus lens to focus on a reference chart that is arranged at a given distance on the observation light path is performed by moving the focus lens from the close-up end in the infinity end direction, which is the same direction as reset drive. The focus lens is driven in the drive direction and position of the focus lens where the reference chart is focused on is detected. Determination of focus is performed by detecting a peak of contrast (AF evaluation value) based on image data that has been output by the imaging section (image sensor). In this way, reference chart position X, which is a position where the focus lens focuses on the reference chart, is detected, and the control lens position (control LD pulse) on the horizontal axis is put into 1:1 correspondence with the system administration lens position on the vertical axis.

At the time of focus drive of the focus lens, if the drive direction is reversed mechanical slip (backlash) exists, and so until this slack is taken up position of the focus lens 11a is not actually changed, even if control LD pulse (horizontal axis in FIG. 5) changes. In order to achieve a target focus position, backlash correction (drive) is performed to drive until the slip is removed, each time the drive direction is reversed.

Target position when performing focusing of the focus lens 11a is designated using system administration position of the focus lens shown on the vertical axis in FIG. 5. In FIG. 5, with drive in the drive directions Aa and Ab shown by dot and dash lines and drive directions Ba and Bb shown by two-dot chain lines, correction of a backlash portion in the system administration position (pulses) that has been designated is performed to calculate control LD pulse, and backlash correction (drive) is performed. In FIG. 5 Pls_LDbk_Adj represents backlash pulses, and this is equivalent to the previously described slip portion.

Control LD pulse to focus the focus lens 11a on a reference chart position X changes depending on position of the camera section 10. This is called Fc deviation, as was described previously. Therefore, Fc pulse correction control is performed in accordance with position of the camera section 10. Reference chart position is orthogonal to the outer housing 42 (or the photographing lens optical axis), and is a reference chart position for adjustment that has been arranged at a given distance.

As was described previously, in FIG. 5, with the example shown in loop A Fc deviation is 0. Drive directions Aa and Ab represent movement at the time of backlash correction, and drive directions Ac and Ad are a case of being driven in the same direction as the reset drive direction (close-up end→infinity end). When being driven in the reset drive direction, the system administration position of the focus lens and the control LD pulse coincide.

In a case where the camera section 10 is at a position where there is no Fc deviation, such as shown in loop A, for control LD pulse XPls the focus lens is in a state of being focused at the reference chart position (focused state). At this time, the system administration position of the focus lens and the control LD pulse coincide in Pls Units, and are made XPls.

In a case where the camera section 10 is at a position where Fc deviation is not 0, such as shown in loop B, namely at a position where there is Fc deviation, system administration position for loop A corresponding to reference chart position X has only Fc correction pulse Calc_Comp_Fc_Pls (D) corrected, and control LD pulse (X+D) corresponding to reference chart position X for loop B is calculated. In this way, in the case of loop B, by correcting control LD pulse with Fc correction pulses corresponding to loop B it is possible to focus at the reference chart position, even in the state of loop B as shown in FIG. 5.

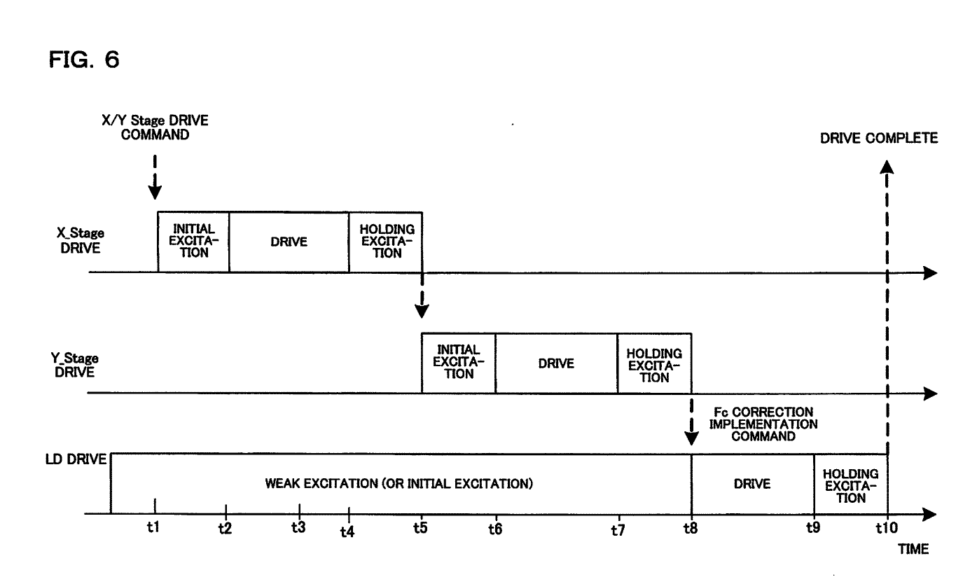

Next, an operation sequences for drive of the camera section 10 (X/Y stage drive) and for focus lens drive (LD drive) will be described using FIG. 6.

The upper part of FIG. 6 shows X stage drive. X stage drive is the XMT control section 62 within the CPU 60 moving the camera section 10 (LD unit 12) in the X axis direction using the X stage drive mechanism 52 by means of the X stage motor driver 54 and the X stage motor 53. With X stage drive, first initial excitation of the X stage motor 53 (stepping motor) is performed at time t1. Then, in the period from time t2 to time t4 pulses are applied to the X stage motor 53 and in this way the camera section 10 is moved to a target position in the X axis direction. Then, in the period from time t4 to time t5 holding excitation is performed in the stepping motor.

The middle part of FIG. 6 shows Y stage drive. Y stage drive is the YMT control section 64 within the CPU 60 moving the camera section 10 (LD unit 12) in the Y axis direction using the Y stage drive mechanism 59 by means of the Y stage motor driver 57 and the Y stage motor 58. With Y stage drive, first initial excitation of the Y stage motor 58 (stepping motor) is performed at time t5. Then, in the period from time t6 to time t7 pulses are applied to the Y stage motor 58 and in this way the camera section 10 is moved to a target position in the Y axis direction. Then, in the period from time T7 to time t8 holding excitation is performed in the stepping motor.

The lower part of FIG. 6 shows focus lens drive (LD drive). The example shown in FIG. 6 is a case where Fc correction drive is implemented. First, in the period from after reset drive until time t8, weak excitation or initial excitation are performed. Weak excitation means excitation with applied voltage of the LD motor 12b being lower than for a normal excitation. Specifically, when commencing focus lens drive from a state where weak excitation is not being performed (weak excitation off state), initial excitation is performed in this weak excitation period. In a state where weak excitation continues as a result of performing live view display etc., weak excitation is performed in this weak excitation period.

In focus lens drive (LD drive), if time t8 is reached then X stage drive and Y stage drive are terminated, the camera section 10 arrives at the target position, an Fc correction execution command is issued from the LD motor control section 61 of the CPU 60 to the LD motor driver 51, and Fc correction drive is executed. Fc correction drive is terminated once time t9 is reached, and until time t10 holding excitation is performed and drive is completed. After that, although not shown in the drawings there is a switch to weak excitation and a standby state is entered.

It should be noted that with this embodiment, the X stage and the Y stage are sequentially driven, but if the power supply is sufficient the X stage drive and Y stage drive may be executed simultaneously.

Next, an Fc adjustment data region that is used when calculating Fc correction value corresponding to position of the camera section 10 (X/Y stage position) will be described using FIG. 7. In FIG. 7, stage positions ST0 to ST24 with white circles attached correspond to Fc adjustment points 0 to 24, and region a to region p are rectangular regions joining stage positions ST0 to ST24. The peripheral regions around the regions a to p are named with a quotation mark (′) when they include two stage positions ST, and named with a double quotation mark (″) in a case where only one stage position ST is included.

FC correction adjustment values are measured at the manufacturing stage as positions of the stage positions ST0 to ST24, and stored in non-volatile memory within the storage section 71. In this adjustment process at the manufacturing stage, a predetermined height that is higher than the LD unit 12 (camera section 10) is made a reference height, a reference chart is placed at this position, focusing is performed using AF (Auto Focus) such as a contrast method, a number of LD pulses until the focus lens 11a reaches the focused point (pulses applied to the LD motor 12b after reaching the reference position) is obtained, and this obtained number of pulses is made the Fc correction adjustment value.

In regions a to p that have neither a quotation mark or a double quotation mark attached, since Fc correction adjustment values are stored for the four corners (adjustment points) of the regions, Fc correction values for each position within each region can be calculated by interpolation calculation of Fc adjustment values for the 4 points. Calculation of region boundaries uses origin side data. For example, a boundary between region a and region e is calculated with region a.

For regions that have a quotation mark attached, it is possible to calculate Fc correction value by extrapolating and interpolating Fc correction pulses for four corners of an adjacent region. For regions that have a double quotation mark attached, it is possible to calculate Fc correction value by extrapolating and interpolating Fc adjustment values for four corners of a region that is adjacent at a single point. For example, for regions a′ and a″, interpolation calculation is performed by extrapolating using Fc adjustment values for region a.

An example of Fc adjustment values stored in the storage section 71 is shown in FIG. 8. The left column shows stage positions ST0 to ST24, and the right column shows Fc adjustment values Fc_Adj_Pos_i. Here, “i” is a suffix for 25 values of 0 to 24, and corresponds to the stage position number.

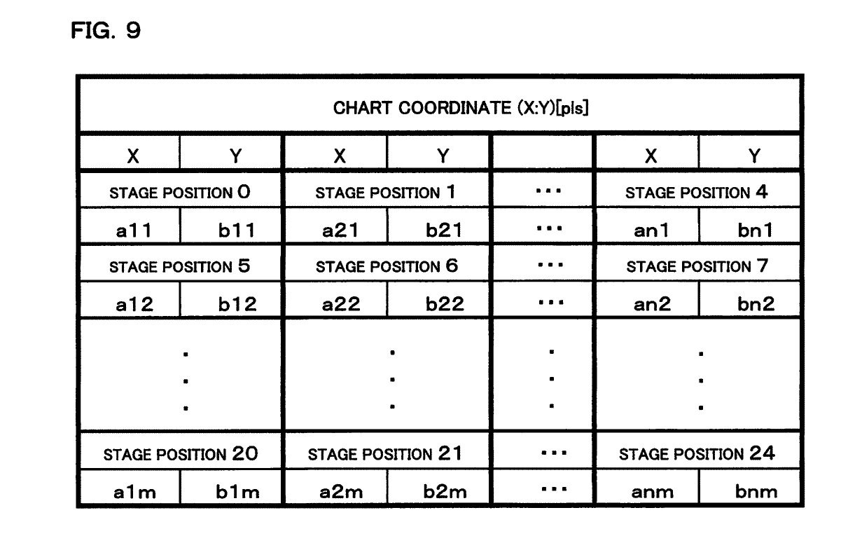

It should be noted that Fc adjustment values may be stored for each coordinate position, as shown in FIG. 9. With the example shown in FIG. 9, X coordinates and Y coordinates are stored together for respective stage positions 0 to 24.

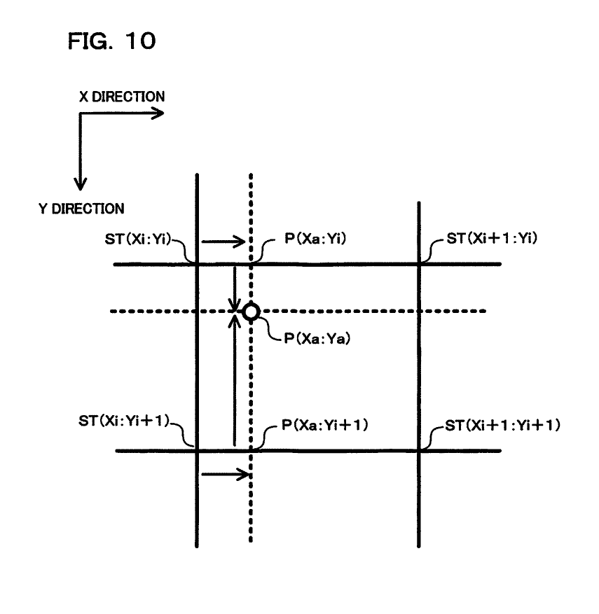

Next, a method of calculating Fc correction value by interpolation calculation from a Fc adjustment value will be described using FIG. 10. Fc correction value corresponding to current position of the camera section 10 (LD unit 12) (X/Y stage position) is calculated using the previously described Fc adjustment value. The calculation procedure is as described in the following.

FIG. 10 shows a case where Fc correction value is calculated using interpolation processing, for a coordinate between coordinates having Fc adjustment values in both the X direction and the Y direction. Fc adjustment value Fc_Adj_k1 corresponding to position of the stage position ST (Xi:Yi) is stored. Fc adjustment value Fc_Adj_k2 corresponding to position of the stage position ST (Xi+1:Yi) is stored. Fc adjustment value Fc_Adj_k3 corresponding to position of the stage position ST (Xi:Yi+1) is stored. Fc adjustment value Fc_Adj_k4 corresponding to position of the stage position ST (Xi+1:Yi+1) is stored.

Position P(Xa:Ya) is a position at which it is desired to calculate Fc correction value using interpolation calculation. Fc correction value that has been calculated using interpolation calculation at this position P is made Calc_Comp_Fc_Pls. This Fc correction value Calc_Comp_Fc_Pls is calculated using the computational processing described in the following.

First, Fc adjustment value Fc_calc1 is calculated using equation (1) below, based on X axis direction linear interpolation processing at position P(Xa:Y1). It should be noted that in equations (1) to (3) below “*” means multiplication.

Fc_calc1=Fc_Adj_ki1(Xa−Xi)/Xᵢ₊₁−Xᵢ)*Fc_Adj_k2−Fc_Adj_k1) (1)

It should be noted that calculation results are rounded off to n decimal places after the decimal point to (n−1) decimal places.

Next, Fc adjustment value Fc_calc2 is calculated using equation (2) below, based on X axis direction linear interpolation processing at position P(Xa:Y1+1).

Fc_calc2=Fc_Adj_k3+(Xa−Xi)/Xᵢ₊₁−Xᵢ)*Fc_Adj_k4−Fc_Adj_k3) (2)

It should be noted that calculation results are rounded off to (n−1) decimal places by rounding off to n decimal places after the decimal point.

Next, Fc adjustment value Fc_calc3 is calculated using equation (3) below, based on Y axis direction linear interpolation processing at position P(Xa:Ya).

Fc_calc3=Fc_Calc1+(Ya−Yi)/Yᵢ₊₁−Yᵢ)*Fc_Calc2−Fc_Calc1) (3)

Calculation results are rounded to a whole number. This Fc_Calc3 that has been calculated using equation (3) is made Fc correction value Calc_Comp_Fc_Pls.

In the peripheral regions a′, a″, d′, d″, n′, n″, p″ and p″ also, calculation is performed using the previously described equations (1) to (3) as computing equations for performing linear interpolation.

Next, Fc correction value that takes into consideration environment temperature will be described using FIG. 11. FIG. 11 is a temperature Fc correction table for a case where process temperature at the time of manufacture has 25° C. as a reference temperature. The left column shows stage position, the same as in FIG. 8, and temperature Fc correction values corresponding to 20° C., 25° C., . . . , 40° C., 45° C. are sequentially shown in the column to the right of the left column. It should be noted that in FIG. 11 25° C. has been made a reference temperature, but this is only an example, and a different temperature may also be made the reference temperature.

The top board 40 sags due to its level of rigidity, and the amount of this sag differs in accordance with position (X/Y stage position) of the camera section 10 (LD unit 12). The amount of sag also differs in accordance with temperature change. Therefore, with this embodiment, Fc adjustment values are stored for every position and temperature, as shown in FIG. 11. It should be noted that change for every position may be disregarded, and temperature Fc correction performed for every temperature. Specifically, on the assumption that Fc deviation due to optical characteristics occurs with temperature change, optical Fc deviation correction may be performed using temperature Fc correction.

With the table shown in FIG. 11, temperature Fc adjustment values are stored for every 5° C. corresponding to device interior temperature for given device exterior temperature conditions. In a case where temperature that has been detected by the device interior temperature sensor 43a is an intermediate temperature, temperature Fc correction value is calculated by linear interpolation calculation using the table data shown in FIG. 11. After that, an Fc correction value depending on XY position is calculated using the previously described equations (1) to (3). With the table shown in FIG. 11, 25° C. is made a temperature at the time of adjustment, and temperature Fc adjustment values are stored every 5° C. At this time, a device exterior temperature condition is made 25° C. Also, in a case of being applied to a cell observation device, since internal temperature of a constant temperature oven is generally set to 37° C., 37° C. is made a temperature at the time of adjustment and table data is created with temperature Fc adjustment values every 2° C. A device exterior temperature condition at this time may also be made 37° C.

Temperature correction is performed using the table shown in FIG. 11, as described in the following. As a first temperature correction method, Fc correction value corresponding to temperature Ta that has been detected by the device interior temperature sensor 43a is calculated. For example, temperature at the time of creating an Fc adjustment value table is set to reference temperature T0, and a difference between a temperature Fc adjustment value for temperature Ta and a temperature Fc adjustment value for reference temperature T0 is made temperature Fc correction value1. Also, a plurality of tables may be created under a plurality of difference device exterior temperature conditions, and stored. Based on temperature that has been detected by the device exterior temperature sensor 44d, temperature Fc correction value may also be obtained by selecting a table corresponding to the detected device external temperature, from among the plurality of tables.

As a second temperature correction method, in the table shown in FIG. 11, instead of device interior temperatures (20, 25, . . . 40, 45), a table (not shown) is created that relates to temperature differences based on difference between device exterior temperature and device interior temperature (−15, −10, . . . 10, 15), and this table is stored in the storage section 71. A difference between temperature Ta detected by the device interior temperature sensor 43a and a temperature Tb detected by the device exterior temperature sensor 44d is then obtained, and applied in calculating temperature Fc correction value 2 based on the table relating to the above-described temperature difference and temperature difference (Tb−Ta). Temperature Fc correction value may also be set by combining (adding) temperature Fc correction value 1 and temperature Fc correction value 2.

Next, Fc correction value that takes into consideration environment pressure will be described using FIG. 12. FIG. 12 is a pressure Fc correction table for a case where process pressure at the time of manufacture is set to a reference pressure of 1013 hpa. The left column shows stage position, the same as in FIG. 8, and pressure Fc correction value corresponding to pressures of 923 hpa, 943 hpa, . . . , 1013 hpa, 1023 hpa are sequentially shown in the column to the right of that. It should be noted that although 1013 hpa has been set as a reference pressure in FIG. 12, this is only an example and a different pressure may be set as the reference pressure.

Amount of sag of the top board 40 differs depending on change in pressure. Therefore, with this embodiment, Fc adjustment values are stored for every position and pressure, as shown in FIG. 12. It should be noted that change for every position may be disregarded, and pressure Fc correction performed for every pressure. Specifically, Fc deviation due to optical characteristics occurs with pressure change, and optical Fc deviation correction may be performed using pressure Fc correction.

With the table shown in FIG. 12, pressure Fc adjustment values are for stored every 20 hpas corresponding to device interior pressure for given device exterior pressure conditions. In the event that pressure that has been detected by the device interior pressure sensor 43b is an intermediate pressure, pressure Fc correction value is calculated by linear interpolation calculation from table data shown in FIG. 12. After that, an Fc correction value depending on XY position is calculated using the previously described equations (1) to (3).

Correction is performed using the table shown in FIG. 12, as described in the following. As a first pressure correction method, Fc correction value corresponding to pressure Pb that has been detected by the device interior pressure sensor 43b is calculated. For example, pressure at the time of creating an Fc adjustment value table is set to reference pressure P0, and a difference between a pressure Fc adjustment value for pressure Pb and a pressure Fc adjustment value for reference pressure P0 is made pressure Fc correction value1. Also, a plurality of tables may be created under a plurality of different device exterior pressure conditions, and stored in the storage section 71. Based on pressure that has been detected by the device exterior pressure sensor 44e, pressure Fc correction value may also be obtained by selecting a table corresponding to the detected device exterior pressure, from among the plurality of tables.

As a second pressure correction method, in the table shown in FIG. 12, instead of device internal pressures (923, 943, . . . 1013, 1023), a table (not shown) is created that relates to pressure differences based on difference between device exterior pressure and device interior pressure (−50, −40, . . . 40, 50), and this table is stored in the storage section 71. A difference between pressure Tb detected by the device interior pressure sensor 43b and a pressure Te detected by the device exterior pressure sensor 44e is then obtained, and applied in calculating pressure Fc correction value2 based on the table relating to the above-described pressure differences and pressure difference (Pe−Pb). Pressure Fc correction value may also be set by combining (adding) pressure Fc correction value 1 and pressure Fc correction value 2.

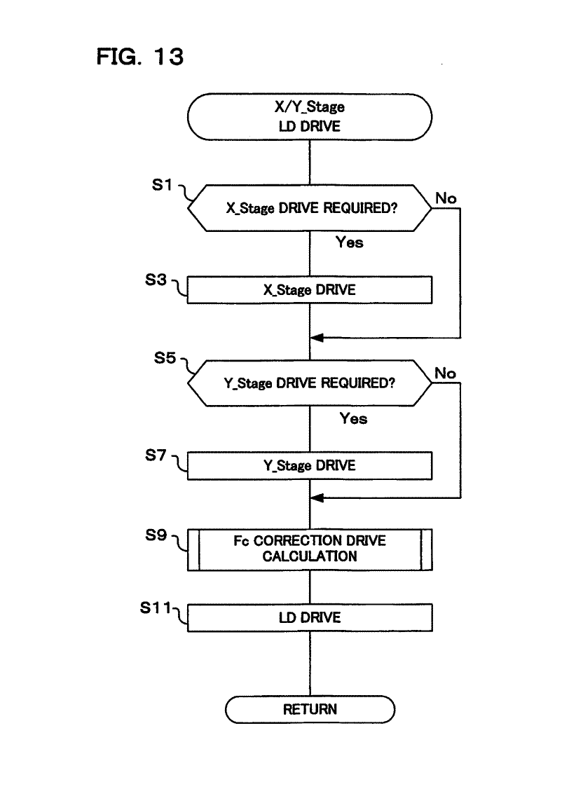

Next, drive operation of the camera section 10 (LD unit 12) will be described using the flowcharts shown in FIG. 13 to FIG. 17. These flowcharts are executed by the CPU 60 controlling each of the sections within the cell observation device 1 in accordance with a program that has been stored within the storage section 71 (storage medium). It should be noted that a focusing operation of the focus lens 11a shown in these flowcharts is not an AF operation performed when still picture shooting, but a focus operation performed at the time of a live view operation for cell observation.

If the flow for X/Y stage LD drive shown in FIG. 13 is entered, it is first determined whether or not X stage drive is required (S1). If described using FIG. 1, the X stage drive is drive to move the camera section 10 in the X axis direction by the X actuator 31b and the X feed screw 32b. Also, if described with FIG. 2A, X stage drive is drive to move the LD unit 12 in the X axis direction using the X stage motor driver 54, X stage motor 53, and X stage drive mechanism 52. There may be cases where the camera section 10 (LD unit 12) is moved automatically to a predetermined position, and cases where the camera section 10 (LD unit 12) is moved by the observer to a position that has been manually set. In this step it is determined whether or not to move the camera section 10 (LD unit 12) in the X axis direction, and with which settings.

If the result of determination in step S1 is that X stage drive is required, X stage drive is performed (S3). Here, the LD unit 12 is moved in the X axis direction using the X stage motor driver 54, X stage motor 53, and X stage drive mechanism 52.

If Y stage drive has been performed, or if the result of determination in step S1 was that X stage drive was not required, it is next determined whether or not Y stage drive is required (S5). If described using FIG. 1, the Y stage drive is drive to move the camera section 10 in the Y axis direction using the Y actuator 31a and the Y feed screw 32a. Also, if described with FIG. 2A, Y stage drive is drive to move the LD unit 12 in the Y axis direction using the Y stage motor driver 57, Y stage motor 58, and Y stage drive mechanism 59. As described previously, there may be cases where the camera section 10 (LD unit 12) is moved automatically to a predetermined position, and cases where the camera section 10 (LD unit 12) is moved by the observer to a position that has been manually set. In this step it is determined whether or not to move the camera section 10 (LD unit 12) in the Y axis direction, and with which settings.

If the result of determination in step S5 is that Y stage drive is required, Y stage drive is performed (S7). Here, the LD unit 12 is moved in the Y axis direction using the Y stage motor driver 57, Y stage motor 58, and Y stage drive mechanism 59.

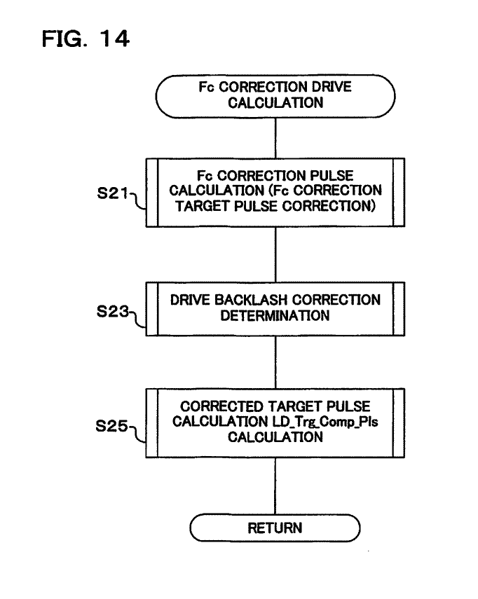

If Y stage drive has been performed, or if the result of determination in step S5 is that Y stage drive was not required, next Fc correction drive calculation is performed (S9). Here, the Fc correction value that was described using FIG. 4A to FIG. 12 is calculated. Detailed processing of the Fc correction drive calculation will be described later using FIG. 14.

If Fc correction drive has been performed, next focus lens drive (LD drive) is performed (S11). Here, focusing of the focus lens 11a is performed using the Fc correction value that was calculated in step S9. If LD drive has been performed, the originating flow is returned to.

Next, detailed processing for Fc correction drive calculation will be described using the flowchart shown in FIG. 14.

If the flow for Fc correction drive calculation is entered, first Fc correction pulse calculation is performed (S21). Here, Fc correction target pulse Calc_Comp_Fc_Pls (refer to FIG. 5) is calculated. In this calculation, calculation of Fc deviation correction corresponding to XY position of the camera section 10 that was described using FIG. 7 to FIG. 10, temperature Fc deviation correction that was described using FIG. 11, and pressure Fc deviation correction that was described using FIG. 12, are performed. It should be noted that if there is no problem regarding precision, one or both of the temperature Fc deviation correction and the pressure Fc deviation correction may be omitted. Detailed processing of this XY position FC deviation correction will be described later using FIG. 15.

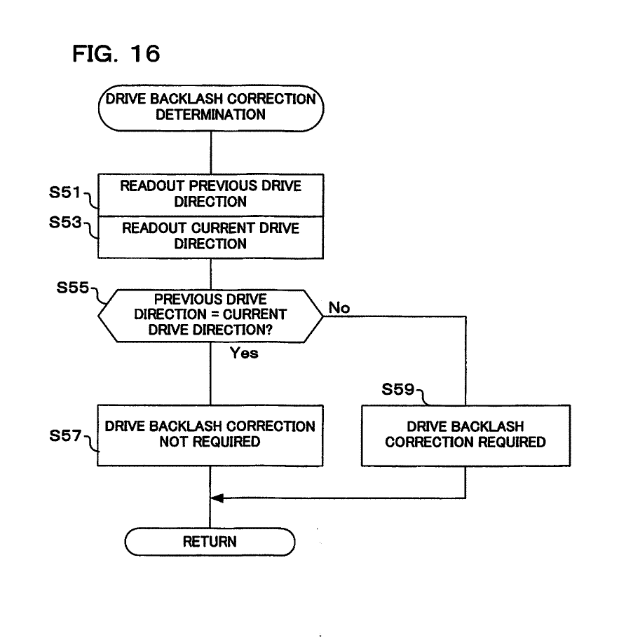

If Fc correction pulse calculation has been performed, next drive backlash correction determination is performed (S23). Here, the drive backlash correction that was described using FIG. 5 is performed. Detailed processing for this drive backlash correction determination will be described later in using FIG. 16.

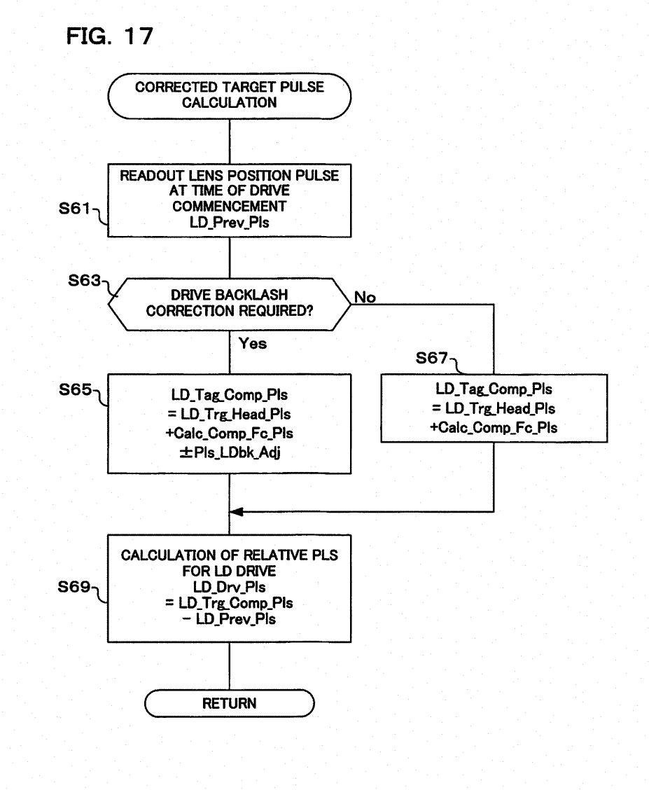

Once drive backlash correction determination has been performed, next corrected target pulse is calculated (S25). Here, corrected target pulse LD_Trg_Comp_Pls is calculated using Fc correction target pulse that was calculated in step S21, lens position at the time of drive commencement, and backlash correction based on drive backlash determination result of step S23. Detailed processing for this corrected target pulse calculation will be described later using FIG. 17. Once corrected target pulse has been calculated, the originating flow is returned to.

Next, detailed processing of the Fc correction pulse calculation of step S21 (refer to FIG. 14) will be described using the flowchart shown in FIG. 15.

If the flow for Fc correction pulse calculation is entered, first XY position Fc deviation correction is performed (S31). Here, current position (XY position) of the camera section 10 (LD unit 12) is detected, Fc adjustment value for X/Y stage position corresponding to a region in which the current position belongs is read out from the Fc adjustment value table (refer to FIG. 8) stored in the storage section 71 (refer to FIG. 7), and Fc correction value corresponding to the current position is calculated by interpolation calculation using this Fc adjustment value that has been read out (refer to FIG. 10).

Once XY position FC deviation correction has been performed, it is next determined whether or not temperature FC deviation correction will be performed (S33). Here, it is determined whether or not to perform temperature Fc deviation correction, based on temperatures that have been detected by the device interior temperature sensor 43a and the device exterior temperature sensor 44d. It should be noted that in a case where temperature Fc deviation correction is not performed, steps S33 and S35 may be omitted. Regarding whether or not to perform first temperature Fc deviation correction, it is determined to perform first temperature Fc deviation correction if an absolute value of a difference between device interior temperature Ta and a reference temperature T0 (Ta−T0) is larger than a first temperature threshold value. Also, regarding whether or not to perform second temperature Fc deviation correction, it is determined to perform second temperature Fc deviation correction if a difference between device interior temperature Ta and device exterior temperature Tb (Tb−Ta) is larger than a second temperature threshold value.

If the result of determination in step S33 is to perform temperature Fc deviation correction, temperature Fc deviation correction is performed (S35). Here, using current position (XY position) of the camera section 10 (LD unit 12) that was detected in step S31, temperature Fc adjustment value corresponding to a region in which the current position belongs is readout from the temperature Fc adjustment value table stored in the storage section 71 (refer to FIG. 11), and temperature Fc correction value corresponding to the current position is calculated by interpolation calculation using this temperature Fc adjustment value that has been read out (refer to FIG. 10). In the event that first temperature Fc deviation correction is performed, correction is performed using temperature Fc correction value1, while if second temperature Fc deviation correction is performed, correction is performed using temperature Fc correction value2.

Once temperature Fc deviation correction has been performed, or if the result of determination in step S33 was to not perform temperature Fc deviation correction, it is next determined whether or not to perform pressure Fc deviation correction (S37). Here, it is determined whether or not to perform pressure Fc deviation correction based on pressures that have been detected by the device interior pressure sensor 43b and the device exterior pressure sensor 44e. It should be noted that in a case where pressure Fc deviation correction is not performed, steps S37 and S39 may be omitted. Regarding whether or not to perform first pressure Fc deviation correction, it is determined to perform first pressure Fc deviation correction if an absolute value of a difference between device interior pressure Pa and a reference pressure P0 (Pa−P0) is larger than a first pressure threshold value. Also, regarding whether or not to perform second pressure Fc deviation correction, it is determined to perform second pressure Fc deviation correction if a difference between device interior pressure Pa and a device exterior pressure Pb (Pb−Pa) is larger than a second pressure threshold value.

If the result of determination in step S37 is to perform pressure Fc deviation correction, pressure Fc deviation correction is performed (S39). Here, using current position (XY position) of the camera section 10 (LD unit 12) that was detected in step S31, pressure Fc adjustment value corresponding to a region in which the current position belongs is read out from the pressure Fc adjustment value table stored in the storage section 71 (refer to FIG. 12), and pressure Fc correction value corresponding to the current position is calculated by interpolation calculation using this pressure Fc adjustment value that has been read out (refer to FIG. 10). In the event that first pressure Fc deviation correction is performed, correction is performed using pressure Fc correction value1, while if second pressure Fc deviation correction is performed, correction is performed using pressure Fc correction value2.

Once pressure Fc deviation correction has been performed, or if the result of determination in step S37 was not to perform pressure Fc deviation correction, next Fc correction pulse Calc_Comp_Fc_Pls is calculated (S41). Here, the XY position FC deviation correction Pls that was calculated in step S31, the temperature FC deviation correction Pls that was calculated in step S35 and the pressure FC deviation correction Pls that was calculated in step S39 are added, and the result of this addition is made Fc correction pulse. Once Fc correction pulse has been calculated the originating flow is returned to.

Next, detailed processing of the drive backlash correction determination of step S23 (refer to FIG. 14) will be described using the flowchart shown in FIG. 16. In this flow it is determined whether or not the previous drive direction and the current drive direction coincide, and if the drive directions do not coincide correction of a drive backlash portion is performed.

If the flow for drive backlash correction determination is entered, the previous drive direction is read out (S51), and the current drive direction is read out (S53). The XMT control section 62 and the YMT control section 64 within the CPU 60 store drive directions for when driving the X stage motor 53 and the Y stage motor 58, and so in this step the drive directions that have been stored are read out.

It is next determined whether or not the previous drive direction and the current drive direction coincide (S55). Here, determination is based on the drive directions that were read out in steps S51 and S53.

If the result of determination in step S55 is that the drive directions coincide, it is determined that drive backlash correction is not required (S57). Since the drive directions coincide, drive backlash does not occur, and so drive correction is not required.

If the result of determination in step S55 is that the drive directions do not coincide, it is determined that drive backlash correction is required (S59). Since the drive directions do not coincide, drive backlash occurs, and so drive correction is required.

If there has been determination regarding drive backlash correction has been determined in step S57 or S59 the flow for drive backlash correction determination is terminated and the originating flow is returned to.

Next, detailed processing of the corrected target pulse calculation of step S25 (refer to FIG. 14) will be described using the flowchart shown in FIG. 17.

If the flow for corrected target pulse calculation is entered, first lens position pulse at the time of drive commencement is read out (S61). XMT control section 62 and the YMT control section 64 within the CPU 60 read out lens position pulse that has been stored as current position, when commencing drive of the X stage motor 53 and the Y stage motor 58, and this pulse that has been read out is made LD_Prev_Pls. It should be noted that this lens position pulse is a lens position that has been calculated, after having detected a reference position using the focus lens reference position detection section 12c, based on pulses that have been applied to the LD motor 12b at the time of drive with this reference position as a reference. This lens position is expressed as Pls. Then, at the time drive is completed, lens position pulse is stored as current position.

Next it is determined whether or not drive backlash correction is required (S63). It is determined in step S57 or S59 (refer to FIG. 16) whether or not drive backlash correction is required, and the result of this determination is stored, and so in this step determination is based on this stored determination.

If the result of determination in step S63 is that drive backlash is not required, corrected target LD pulse LD_Tag_Comp_Pls is calculated (S67). Here, target LD pulse LD_Tag_Comp_Pls is calculated based on equation (4) below.

LD_Tag_Comp_Pls=LD_Trg_Head_Pls+Calc_Comp_Fc_Pls (4)

In equation (4) above, target LD pulse LD_Tag_Comp_Pls is represented as an absolute value Pls. Specifically, absolute value Pls represents lens position, and as was described previously, a reference position is detected by the focus lens reference position detection section 12c, and after that absolute value Pls is calculated based on number of pulses that have been applied in order to drive the LD motor 12b, with this reference position as a reference.

Also, LD_Trg_Head_Pls in equation (4) above represents target LD pulse corresponding to an administrative position has been output from an external device such as the operation section 20, or from an AF control block within the CPU 60. Also, at the time of live view display that is performed at the time of cell observation, current focus lens position LD_Prev_Pls becomes LD_Trg_Head_Pls.

Also, Calc_Comp_Fc_Pls in equation (4) above is Fc correction pulse Calc_Comp_Fc_Pls that was calculated in step S41 (refer to FIG. 15).

On the other hand, if the result of determination in step S63 is that drive backlash is required, corrected target LD pulse LD_Tag_Comp_Pls that takes drive backlash into consideration is calculated (S65). Here, target LD pulse LD_Tag_Comp_Pls is calculated based on equation (5) below.

LD_Tag_Comp_Pls=LD_Trg_Head_Pls+Calc_Comp_Fc_Pls±Pls_LDbk_Adj (5)

LD_Trg_Head_Pls+Calc_Comp_Fc_Pls in equation (5) above is the same as for equation (4) above, and so detailed description is omitted. ±Pls_LDbk_Adj in equation (5) above is LD backlash pulse, and is a correction value for correcting drive backlash. The symbol “±” means that sign becomes “−” if drive direction is in the close-up direction, and sign becomes “+” if drive direction is in the infinity direction. This LD backlash pulse Pls_LDbk_Adj is an adjusted value that has been adjusted by backlash adjustment, and is an adjustment value (pulses) that is not dependent on an X/Y stage position and focus lens position.

If the target LD pulse LD_Tag_Comp_Pls has been calculated in step S65 or S67, next relative Pls to perform LD drive is calculated (S69). Target LD pulse LD_Tag_Comp_Pls that was calculated in step S65 or S67 is pulses Pls representing absolute position from the reference position of the focus lens. In this step, relative movement amount (relative Pls) required to move from current position to the target LD pulse LD_Tag_Comp_Pls is calculated.

Relative Pls is represented as LD_Drv_Pls, and this Pls is calculated using equation (6) below).

LD_Drv_Pls=LD_Trg_Comp_Pls−LD_Prev_Pls (6)

Here, target LD pulse LD_Trg_Comp_Pls is calculated in step S65 or S67. Also, LD_Prev_Pls is lens position pulse at the time of drive commencement, and is read out in step S61. Relative Pls is calculated using these values.

Once relative Pls for performing LD drive has been calculated, the originating flow is returned to. If the originating flow is returned to, in step S11 (referred to FIG. 13) drive of the focus lens 11a is performed using relative Pls that was calculated in step S69, and focus control is performed so that the focus position at the time of dried commencement is maintained.

As has been described above, with one embodiment of the present invention there is an image sensor 12a that forms images of a specimen, and a storage section 71 for storage of a focus map that stores a focus map that associates imaging position with focus control information for focusing on the specimen. Imaging position of the imaging section is then changed (refer to S1 to S7 in FIG. 13), data of a focus map that has been stored is corrected based on the imaging position that has been changed, and focus is controlled based on the focus map that has been corrected (S9 and S11 in FIG. 13). As a result it is possible to correct focus deviation due to deformation of a top plate.

It should be noted that in the one embodiment of the present invention the LD motor control section 61, XMT control section 62, image processing section 63, and YMT control section 64 have been constructed integrally with the CPU 60, but they may also be constructed separately from the YMT control section 64. It is also possible for these sections to have a hardware structure such as gate circuits generated based on a programming language that is described using Verilog, and also to use a hardware structure that utilizes software such as a DSP (digital signal processor). Suitable combinations of these approaches may also be used. Also, some or all of the elements that have been provided outside the CPU 60 may be incorporated into the CPU 60, and may also be implemented using software.

It should be noted that in the one embodiment of the present invention, description has been given using an example where a specimen 81 that is cultivated in culture medium within a vessel 80 is assumed as a measurement object, but this is not limiting, and imaging may be performed while moving the imaging section within a given range, and as long as there is a target portion when performing measurement this is not limiting. The communication method also does not need to be limited to wireless communication, and wired communication may also be used. Besides this, this embodiment is applicable in any remote shooting examination system, device or method that carries out combination of performance examination of products, performance examination of parts and packages, movement control and shooting control.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they be downloaded via the Internet.

Also, with the one embodiment of the present invention, operation of this embodiment was described using flowcharts, but procedures and order may be changed, some steps may be omitted, steps may be added, and further the specific processing content within each step may be altered. It is also possible to suitably combine structural elements from different embodiments.

Also, regarding the operation flow in the patent claims, the specification and the drawings, for the sake of convenience description has been given using words representing sequence, such as “first” and “next”, but at places where it is not particularly described, this does not mean that implementation must be in this order.

As understood by those having ordinary skill in the art, as used in this application, ‘section,’ ‘unit,’ ‘component,’ ‘element,’ ‘module,’ ‘device,’ ‘member,’ ‘mechanism,’ ‘apparatus,’ ‘machine,’ or ‘system’ may be implemented as circuitry, such as integrated circuits, application specific circuits (“ASICs”), field programmable logic arrays (“FPLAs”), etc., and/or software implemented on a processor, such as a microprocessor.

The present invention is not limited to these embodiments, and structural elements may be modified in actual implementation within the scope of the gist of the embodiments. It is also possible form various inventions by suitably combining the plurality structural elements disclosed in the above described embodiments. For example, it is possible to omit some of the structural elements shown in the embodiments. It is also possible to suitably combine structural elements from different embodiments.

What is claimed is:

1. An observation device, comprising:
a focus lens and an image sensor for forming images of a specimen,
a motor drive circuit that changes imaging position of the focus lens and the image sensor on an XY plane,
a controller that controls focus of the focus lens,
a memory that stores a focus map that associates the imaging position with focus control information to focus on the specimen, and
a temperature sensor that measures temperature inside the observation device,
wherein,
the controller corrects data of the focus map stored in the memory based on the imaging position and temperature measured by the temperature sensor, and controls focus based on the focus map that has been corrected.

2. The observation device of claim 1, further comprising:
a pressure sensor that measures pressure inside the observation device, and wherein
the controller corrects the focus map based on pressure that has been measured by the pressure sensor.

3. The observation device of claim 1, further comprising:
an environment sensor that acquire information relating to environment in which the observation device is arranged, and wherein
the controller corrects the focus map based on information that has been acquired by the environment sensor.

4. The observation device of claim 3, wherein:
the information relating to environment is temperature or pressure of the environment.

5. The observation device of claim 1, wherein:
the controller corrects the focus map by estimating change to a light path when the image sensor forms images of the specimen.

6. The observation device of claim 1, further comprising:
a transparent board on which the specimen is arranged, and that is arranged between the specimen and the image sensor, and
a casing that is used together with the transparent board to put the inside of the observation device in a sealed state,
wherein
the focus map is corrected by estimating deformation of the transparent board.

7. The observation device of claim 1, further comprising:
a display that displays image of the specimen on the basis of output of the image sensor, and wherein
the image sensor is capable of imaging corresponding to still images, and imaging corresponding to live view,
the controller is capable of adjusting focus of the focus lens such that contrast becomes a peak, based on image information that has been formed by the image sensor, and
in the event that the image sensor performs an imaging operation corresponding to live view the controller controls focus based on the corrected focus map, and in the event that the image sensor performs an imaging operation corresponding to still images the controller controls focus such that the contrast becomes a peak.

8. A focus control method for an observation device that has a focus lens and an image sensor for forming images of a specimen, and also a memory that stores a focus map that associates the imaging position with focus control information to focus on the specimen, comprising:
changing imaging position of the focus lens and the image sensor on an XY plane,
measuring temperature inside the observation device, and
correcting data of the focus map stored in the memory based on the imaging position and temperature measured by the temperature sensor, and controlling focus of the focus lens based on the focus map that has been corrected.

9. The focus control method for an observation device of claim 8, further comprising:
measuring pressure inside the observation device, and
correcting the focus map based on the pressure that has been measured.

10. The focus control method for an observation device of claim 8, further comprising:
acquiring information relating to environment in which the observation device is arranged, and
correcting the focus map based on the information that has been acquired.

11. The focus control method for an observation device of claim 10, wherein:
the information relating to environment is temperature or pressure of the environment.

12. The control method for an observation device of claim 8, further comprising:
correcting the focus map by estimating change to a light path when the image sensor forms images of the specimen.

13. The control method for an observation device of claim 8, wherein:
the observation device further comprises a transparent board on which the specimen is arranged, and that is arranged between the specimen and the image sensor, and a casing that is used together with the transparent board to put the inside of the observation device in a sealed state, the method further comprising,
correcting the focus map by estimating deformation of the transparent board.

14. The control method for an observation device of claim 8, wherein:
the image sensor is capable of imaging corresponding to still images, and imaging corresponding to live view, and
in the event that the image sensor performs imaging corresponding to live view focus is controlled based on the corrected focus map, and in the event that the image sensor performs an imaging operation corresponding to still images focus is controlled such that the contrast becomes a peak.

15. A non-transitory computer-readable medium storing a processor executable code, which when executed by at least one processor, performs an control method for an observation device that has a focus lens and an image sensor for forming images of a specimen, and also a memory that stores a focus map that associates the imaging position with focus control information to focus on the specimen, the control method comprising:
changing imaging position of the image sensor,
measuring temperature inside the observation device, and
correcting data of the focus map stored in the memory based on the imaging position and temperature that has been measured, and controlling focus of the focus lens based on the focus map that has been corrected.

16. In the non-transitory computer-readable medium of claim 15, the control method further comprises:
measuring pressure inside the observation device, and
correcting the focus map based on the pressure that has been measured.

17. In the non-transitory computer-readable medium of claim 15, the control method further comprises:
acquiring information relating to environment in which the observation device is arranged, and
correcting the focus map based on the information that has been acquired.

18. In the non-transitory computer-readable medium of claim 15,
the information relating to environment is temperature or pressure of the environment.

19. In the non-transitory computer-readable medium of claim 15, the control method further comprises:
correcting the focus map by estimating change to a light path when the image sensor forms images of the specimen.

20. In the non-transitory computer-readable medium of claim 15,
the observation device further comprises a transparent board on which the specimen is arranged, and that is arranged between the specimen and the image sensor, and a casing that is used together with the transparent board to put the inside of the observation device in a sealed state, the method further comprising,
correcting the focus map by estimating deformation of the transparent board.
